(19) United States
(12) Patent Application Publication
(10) Pub. No.: US 2015/0276479 A1
(43) Pub. Date: Oct. 1, 2015

(54) METHOD ACCOUNTING FOR THERMAL EFFECTS OF LIGHTING AND RADIATION SOURCES FOR SPECTROSCOPIC APPLICATIONS

(71) Applicant: Intellectual Property Transfer, LLC, Hollis, NH (US)

(72) Inventors: Joseph E. JOHNSON, Hollis, NH (US); Monique T. CLAVERIE, Farmington, ME (US); Michael J. JOHNSON, Hollis, NH (US); David H. TRACY, Champaign, IL (US)

(73) Assignee: Intellectual Property Transfer, LLC, Hollis, NH (US)

(21) Appl. No.: 14/225,610

(22) Filed: Mar. 26, 2014

(51) Int. Cl. G01J 3/28

(52) U.S. Cl. CPC G01J 3/28

(57) ABSTRACT

A method of spectral measurement utilizing sensing devices that employ light or radiation sources. The method provides a uniform spectra or wavelength intensity reading with respect to the temperature or intensity by using an algorithm that incorporates the thermal aspects of the light or radiation source with the spectral, sensing or color attributes.

### FIELD OF THE INVENTION

This invention is in the field of spectral measurements or other sensing devices that employ lighting and radiation sources. In particular, the present invention relates to providing a more uniform and accurate spectra or wavelength intensity readings with respect to intensity of lighting sources by correlating thermal aspects of the light source and using an algorithm. The wavelength regions that are of particular value include the ultraviolet, visible, infrared, and other spectroscopy methods such as Raman, light scattering and reflection, and fluorescence may be used.

### BACKGROUND OF THE INVENTION

Algorithms, or computer programs, have been used in improving spectroscopic analyses for a variety of applications, some including temperature or thermal measurements. In U.S. Pat. No. 7,760,354, Grun, et. al. utilizes an algorithm to Raman spectroscopy to combine spectral data. Hagler, in U.S. Pat. No. 7,426,446 uses a spectra sorting algorithm to determine calibration training spectra for radiation. Samsoondar, in U.S. Pat. No. 6,828,152 applies algorithms of the absorbance spectra of quality control materials. Schweitzer, et al., in U.S. Pat. No. 7,409,299 uses a ranking program with a spectral library to identify the composition of a sample spectra. Ingram, Jr., et. al., in U.S. Pat. No. 7,117,132 uses an algorithm with the spectra of a surface to estimate the error statistic for a retrieved temperature of a surface material. Ja, et al., in U.S. Pat. No. 7,435,944 uses an algorithm to calculate pressure by measuring the temperature near an optically resonant material during application of a know amount of light. Servaites, et al. in U.S. Pat. No. 6,914,246 describes a method and apparatus to resolve the temperatures profile of flames using ultraviolet light using an algorithm based upon a relationship between a temperature-dependent intensity range within the temperature-dependent wavelength region over a plurality of temperatures. Servaites normalize the intensity range for a given wavelength region and was able to calculate the thermal profile of the flames. Maynard, et al. in U.S. Pat. No. 6,654,125 utilizes current control, temperature control and an algorithm for correcting wave number drift for a laser light source and interferometry. The algorithm is derived from spectroscopic analysis of a reference sample with known spectrum and comparing the generated spectrum to the known spectrum. U.S. Pat. Nos. 6,969,619, 6,830,939 and 6,238,937 describe algorithms that determine the endpoint of a semiconductor processes by monitoring the spectra of the radiation. Johnson, et al. in U.S. Pat. No. 6,116,779 demonstrates an optical method for measuring the temperature of thin film materials such as Gallium Arsenide and Indium Phosphide that have temperature dependent band edges. Thundat, et al. uses an algorithm in U.S. Pat. No. 6,050,722 to determine the temperature of a targeted sample using a non-contact infrared temperature measuring system and micro-mechanical sensors to obtain spectra.

Cok (U.S. Pat. No. 7,158,106) deals with controlling the current input to organic light emitting diodes (OLEDS) or LEDs by measuring the temperature of transistor circuits.

Another Cok patent (U.S. Pat. No. 7,847,764) describes an LED compensation method that measures light output and an algorithm. In a third patent (U.S. Pat. No. 8,013,814) Cok describes a method for a display with OLEDs that deal with input signals to provide a more uniform light output. Algorithms and input signals are used to control light output in Cok's works.

Coates' work (U.S. Pat. Nos. 7,907,282; 7,459,713; 7,057,156 and EP1955033(A2)) describe an instrument that uses an integrated spectral sensing engine which uses software to overlap LED signals and generate spectral readings from a range of 200 nm to 25 um. This invention is integrated into this application.

Thus, algorithms are commonly used in spectral and thermal applications, but not for measuring the light source. Often, the temperature of a sample is measured for temperature and related to the generated spectra. Other applications include controlling a process by monitoring the temperature of a radiation source with time. Still another application is to use electronic input variables combined with algorithms to provide a more uniform light output. In all the applications the focus is on controlling and limiting the light or radiation source, rather than not controlling the light source.

For a general background, common methods of spectral analysis use a system consisting of a light or radiant energy source (e.g., tungsten lamp), a wavelength selector or filter (e.g., a prism, monochromator to produce light with limited and defined wavelengths), a detector or sensor, signal processor and data storage and display unit. The common methods are described in various instrumental analysis books that are referenced herein.

In one method, light waves from the source are broken into specific wavelengths prior to impingement onto or through the sample of interest; this is common for absorption and Raman spectroscopy. In absorption spectroscopy, the transmission of radiation is actually measured and the absorbance calculated using equations 1 and 2:

T=Iₒ/I Equation 1:

A=−log₁₀ T=log (Iₒ/I) Equation 2:

Where:

Iₒ is the intensity of the incident light beam

I is the intensity of the light beam attenuated by the sample

T is the transmittance of the sample, is the fraction of incident light transmitted by the sample

A is the absorbance of the sample

A schematic of key components of an “absorption-type” instrument is shown in FIG. 1.

In another method, the light source initially passes through or is reflected from a sample prior to a wavelength selector and the detector and signal processor and data storage and display; which are common for scattering spectroscopy, color spectrophometers and optical densitometers. The distinction between the absorption and scattering-type instruments is the order of the sample chamber and wavelength selectors. For the “scattering-type” instruments, the light waves are reflected from a solid surface or powder, and then interact with a sensor which measures the amount of light intensity transmitted. The measured intensity is then related back to the initial intensity of light that was produced over a wavelength or wavelength range. The corrected-measured intensities are then compiled, resulting in a spectrum. A schematic of key components of a scattering-type instrument is shown in FIG. 2.

Recently a new instrument has been developed that has component order of a scattering-type instrument, but with the light source transmitting through the sample, reflecting off a back surface, reflecting through the sample again and onto the wavelength selector. This manner uses a “transmission”-type instrument with a schematic in FIG. 3.

A special method of spectral analysis involves fluorescence, luminescence or phosphorescence, where the initial wavelength (excitation wavelength) differs from the sensing wavelength (emission wavelength). In this case there may be separate wavelength selectors before and after the sample. A schematic of the “fluorescent”-type instrument is shown in FIG. 4.

The spectral system has radiation or light sources that vary by wavelengths of energy. Further, the source of radiation should not change dramatically among adjacent wavelengths. In the ultraviolet range, defined as ˜160 nm to ˜400 nm in wavelength, hydrogen or deuterium lamps are used to yield a continuous spectrum. Typically a warm-up time of fifteen minutes is needed to stabilize the intensity of a hydrogen or deuterium lamp.

Light waves for the visible and infrared regions are generated by tungsten, tungsten alloy, or tungsten/halogen lamps. The tungsten lamps have operating temperatures about 2870° K, and require constant voltage regulators, as the filament temperature varies greatly with input voltage. Tungsten lamps emit radiation from 320 nm to 2500 nm. Xenon arc lamps yield radiation from 250 nm to 600 nm in wavelength. Xenon arc lamps can commonly be controlled for a more uniform temperature by regular discharging from a capacitor.

Infrared light sources typically are heated electrically to temperatures from 1500-2000° K. Nerst glower lamps, composed of rare earth oxides, are often used for infrared spectroscopy. The issue with the Nerst lamp is that it has a large temperature coefficient of electrical resistance, and thus be heated externally to maintain a constant temperature. A silicon carbide source, termed “globar”, may also be used for yielding infrared energy. The globar is electrically heated and water cooled to maintain a more constant temperature and intensity. An incandescent wire source, also used in the infrared region, is typically a nickel-chromium or rhodium wire is heated by applying a current. Current regulators are needed to maintain a more uniform temperature, and thus intensity.

Other light sources include metal vapor lamps, such as mercury and sodium vapor lamps. The vapor lamps works by applying an electrical potential across electrodes contain the gaseous element. Initial heating is needed to initial produce metal vapor, and then temperature of the lamp is maintained by applying a constant current. Raman spectroscopy commonly uses mercury arc lamps, and potentially could use helium, cadmium, or argon lamps. Hollow cathode lamps may be used for atomic absorption or atomic fluorescence spectroscopy, and commonly consist of a tungsten anode and a metal cathode in a low pressure neon or argon environment. The metal cathode is of the same element being analyzed. A potential is applied to the lamp causing the metal to form an atomic cloud in a sputtering process. High electrical potentials lead to high currents and greater light intensities, thus a means to regulate the electrical potential is often employed to create a more uniform intensity.

Klystrons, tunnel diodes and laser assisted plasma (LAMP) light sources may be used for microwave spectra. Other light sources that may be used for a variety of wavelengths include lasers, LEDs (light emitting diodes), and flames. The light sources also need electrical regulation for an output of uniform radiation intensity. Further, the listed light sources are examples for various spectral regions and are not inclusive of all light sources.

The spectral systems all lack in that the light sources need an initiation or warm-up time, sometime in the order of ten to sixty minutes, to stabilize the light intensity. An explanation is that the element, electrode or energy generating materials of the lamp needs a thermal equilibration time, as electrons flow from a power source. A second equilibration is needed as the energy generating materials need to stabilize in their environment. A third equilibration occurs as the power to the energy generating materials may vary. In summary, multiple thermal equilibriums are occurring, sometimes simultaneously, causing the resulting light intensity to vary. When the light intensity varies, the spectra or wavelength intensity measurement of a sample will also vary. Thus a need exists to stabilize the light intensity by way of regulating the temperature of the energy generating material(s) or to understands the effect of the temperature and relate that to the intensity and spectra.

One way to improve the light intensity for an instrument is to use a very precise voltage regulator. Such a device will diminish, but not totally remove, fluctuations in light intensity. However, even with a voltage regulator, the voltage still varies in power causing intensity fluctuations.

Another way to deal with intensity fluctuations is to use a “dual-beam” instrument that sends light through a sample and a standard. Two methods exist for a dual beam instrument. The first is to split the light beam, using a beam splitter or prism, or mirrors, such that it passes through both the sample and a standard. The hope is that the light intensities of the two beams are exactly the same upon splitting and going through two different chambers. The second method is to use a chopper-motor or “beam-chopper” to direct the light to the sample and standard intermittently. The error in intensities may be due to the applied electrical potential variations with time. Another issue with an instrument is that a greater light intensities are needed since the light will be interact with other materials and then go through both the sample and the standard to sensors. Thus, the lamp will grade at a faster rate a “single beam” instrument. If a mirror and a beam splitter apparatus is used, the instrument will require additional moving parts, thus increasing space and energy.

A dual-beam instrument is also not practical for all spectroscopic methods, nor does it eliminate all intensity variations.

Another common method to account for lamp degradation is a “single beam” instrument. The single beam instrument uses one measurement chamber, and a standard is measured prior to measuring the sample. Then spectrum of the standard is subtracted from that of the sample to create a “true” spectrum. One major issue with a single-beam instrument is that the light intensities between the sample and the standard may not be the same, so that the “true” sample spectra may not be accurate. The single beam instrument lacks in that the light intensity may change or fluctuate between measurements. Additionally, the multiple measurements employ more resources and time.

The lifetime of a light or energy source may be correlated to the ability of the sensor to detect. At the end of life phase, the light source has a weaker intensity compared to its starting point, causing fluctuation in intensity errors to increase. Often, this is described as a signal to noise ratio, whereby a strong signal (light intensity) is preferred to the noise or error in detection. At the end of the useful life of a lamp the light intensity diminishes so that the noise significantly affects the error in intensity, and therefore the resulting spectrum.

So, a problem exists for spectrophotometers and sensors, including those that measure in the ultraviolet, visible, infrared, and microwave regions including Raman, atomic absorption and fluorescence spectroscopy, and colorimeter and densitometer instruments, in that light source fluctuates in intensity and changes in intensity, resulting in inaccuracies or fluctuations in resulting measurements and spectra.

Further, these light sources often need high intensities to perform well, since the light may be filtered through a prism or colored filter, and reflect off of mirrored and other surfaces, as well as through or reflected from the object of interest. Light sources also inherently generate heat, and thus need a cooling apparatus or fan to dissipate such heat, which also may affect the light intensity due to an additional thermal equilibrium.

Thus, a need exists for a rapid, but accurate and reproducible method for producing more accurate spectra or wavelength intensity readings that can overcome thermal and other issues associated with variable light wave intensities.

### SUMMARY OF THE INVENTION

It is an object of the invention to provide a method for providing a more uniform spectrum or wavelength intensity output in a spectral measuring or sensing device that overcomes the disadvantages described above, in accordance with the methods described herein:

It is another object of the invention to provide a means to measure the temperature of or near a light source and correlate said measurement to the resultant spectra or wavelength intensity of a sample, which is due to the intensity of the light source.

It is a further object of the invention to provide an algorithm that performs the function of normalizing spectra or wavelength intensity to spectra or wavelength intensity at a fixed temperature, thus obtaining a more accurate spectra or wavelength intensity compared to current ones that vary due to thermal or other intensity effects.

Of particular significance, the invention is also directed generally to be used for ultraviolet, visible, infrared and microwave spectrophotometers for analyzing chemical quantity and composition in accordance with the particular instrument. Other spectroscopic methods that can utilize the invention include, but are not limited to, Raman spectroscopy, light scattering and nepholometric means, fluorescence, luminescence, phosphorescence, optical densitometry, atomic absorption, atomic fluorescence, and colorimetric techniques.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of an “absorption”-type instrument for use in conjunction with the present invention.

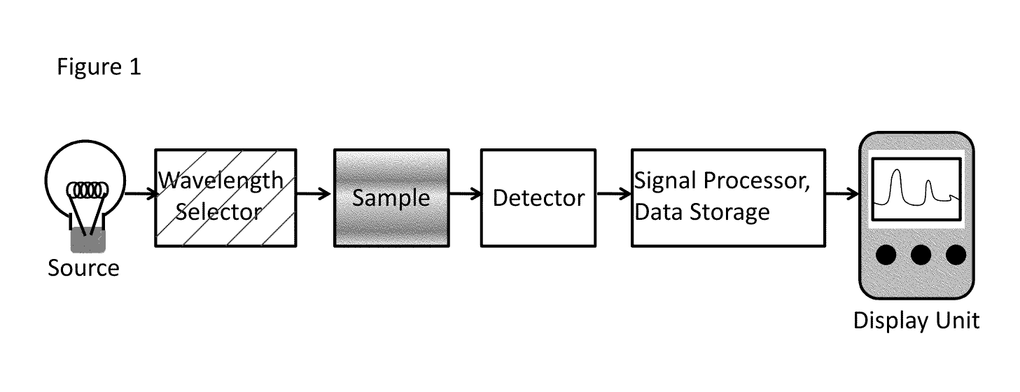

FIG. 2 is a schematic of a “scattering”-type instrument for use in conjunction with the present invention.

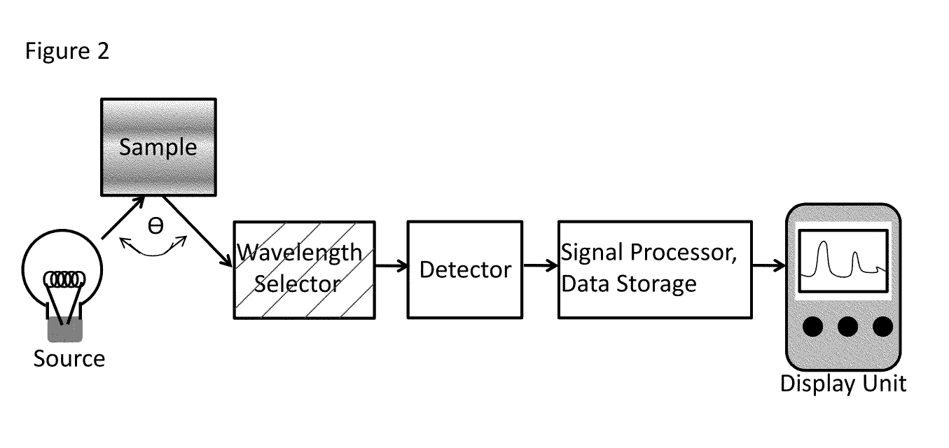

FIG. 3 is a schematic of a “transmission”-type instrument for use in conjunction with the present invention.

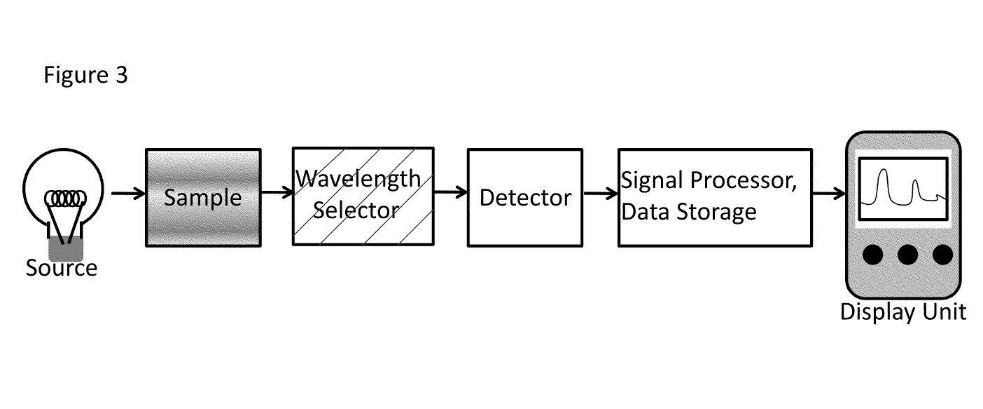

FIG. 4 is a schematic of a “fluorescent”-type instrument for use in conjunction with the present invention.

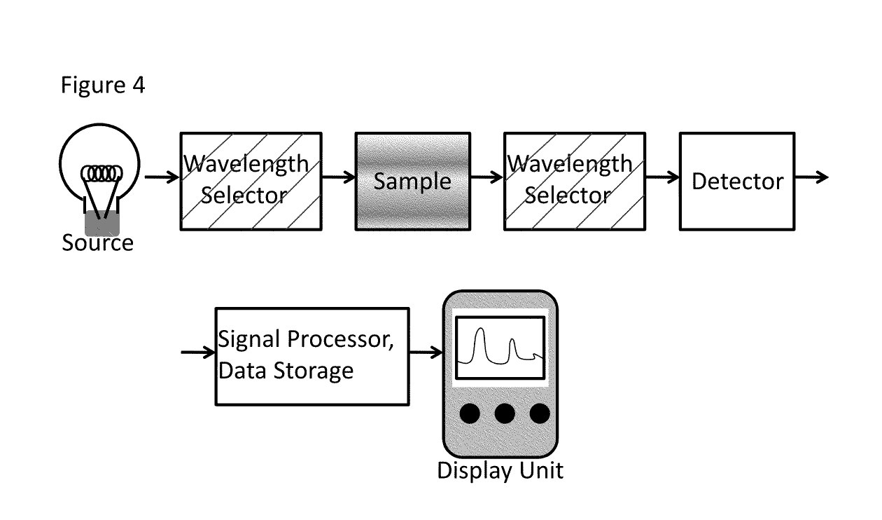

FIG. 5 a graph of absorption spectra as a function of light source temperature for a red color coding label in conjunction with the present invention.

FIG. 6 is a graph of absorbance at 417 nm, 475 nm, and 536 nm as a function of light source temperature for the red color coding label in conjunction with the present invention.

FIG. 7 is a graph for comparison of absorption spectra normalized spectrum at 25° C. for the red color coding label, with spectra measured at 17.31° C. and 29.31° C. in conjunction with the present invention.

FIG. 8 is a graph of the L* values of a function of light source temperature for the red color coding label in conjunction with the present invention.

FIG. 9 is graph of the a* values of a function of light source temperature for the red color coding label in conjunction with the present invention.

FIG. 10 is a graph of the b* values of a function of light source temperature for the red color coding label in conjunction with the present invention.

FIG. 11 is graph absorption spectra as a function of light source temperature for the yellow color coding label in conjunction with the present invention.

FIG. 12 is a comparison of the absorption spectra normalized spectrum at 25° C. for a yellow color coding label, with spectra measured at 15.50° C. and 31.69° C. in conjunction with the present invention.

FIG. 13 is a graph of absorption spectra as a function of light source temperature for a blue color coding label in conjunction with the present invention.

FIG. 14 is a graph for comparison of the absorption spectra normalized spectrum at 25° C. for the yellow color coding label, with spectra measured at 15.36° C. and 30.75° C. in conjunction with the present invention.

### DETAILED DESCRIPTION

Reference will be made to examples of the present invention.

### EXAMPLE 1

A spectrophotometer (i-Lab® Model S560 with surface reader adapter) was initially calibrated with a white Teflon and carbon-based black standards. The goal was to then measure the visible spectra (400 nm to 700 nm) of a red Avery® 5472™ color coding label while the temperature of the light source varied.

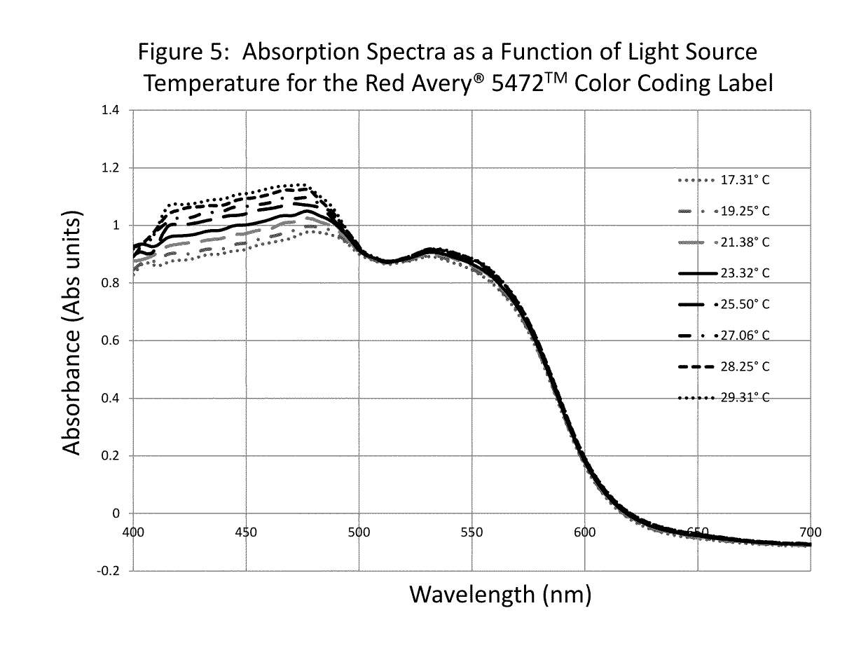

In the study, two stickers were affixed to the bottom of a white Teflon calibrator well. A tubular surface reader adapter on the instrument was then placed into the well. The well was then taped onto the spectrophotometer with black duct tape to ensure that its position would not change. The instrument with attached calibrator was placed into a thermal regulating unit (Euro Cuisine Model YM 100 Yogurt Maker) and allowed to equilibrate for one hour. The instrument with calibrator was then removed from the thermal regulating unit. The instrument was turned on and the temperature of the light source (three LEDs) was measured, as was a spectrum of the immobile, red sticker, and both recorded. The temperature of the light source was measured with an integrated circuit temperature sensor (Microchip TCN75A) with an accuracy of 0.0625° C. over a range from −55° C. to 125° C., that was soldered at a distance of approximately 6 mm from the light source. More spectral readings of the label were taken, as was light source temperatures. The light source increased in temperature due to usage and environmental conditions. A visible spectra of the red label as a function of temperature is shown in FIG. 5.

Note that the general effect is that as the temperature of the light source increases, the Absorbance intensity also increases. This is especially evident near the 550 nm area, and most especially between the 400 nm and 500 nm region. Note also that above −620 the Absorbance is negative relative to the initial black standard.

### EXAMPLE 2

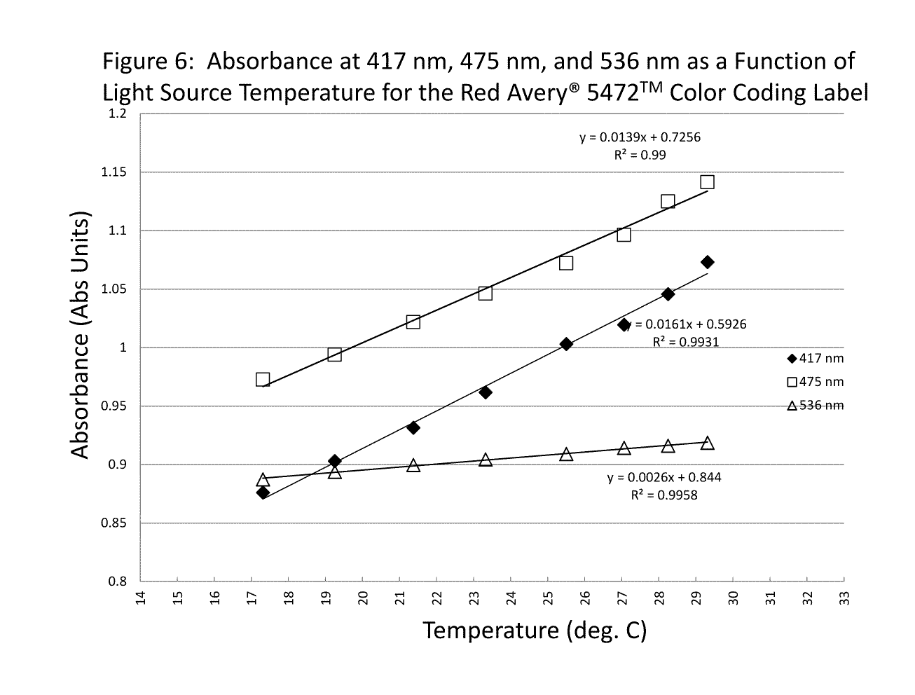

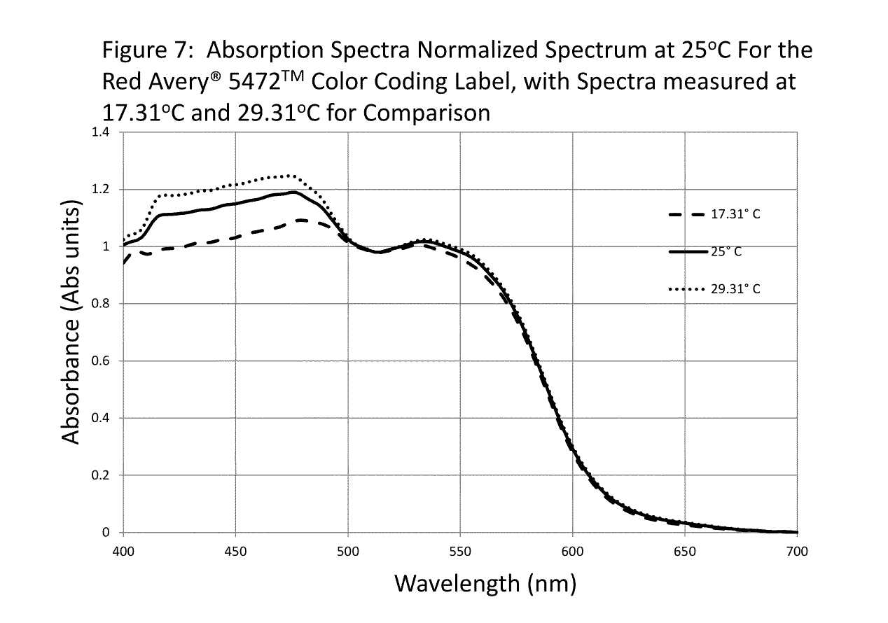

The spectra of EXAMPLE 1 were processed at each wavelength using an algorithm such that a theoretical, normalized spectrum was generated using 25° C. as the reference temperature. FIG. 6 shows the Absorbance of three wavelengths (417 nm, 475 nm, and 536 nm) as a function of temperature from −17° C. to −30° C. that was part of the algorithm. FIG. 6 shows that there is a linear dependency of Absorbance on light source temperature, although the linearity varies at each wavelength. The variance may be attributed to light source differences in intensities since there were three LEDs used, and also absorbance characteristics of the sample. FIG. 7 shows the normalized spectrum from 400 nm to 700 nm using 25° C. as the calculated standard, along with two measured spectra at light source temperatures of 17.31° C. and 29.31 ° C., for comparative purposes. Thus, this example shows that there is a relationship between the temperature of a light source or sources and the resulting spectrum of a sample, in this case a red color coding label, and that by use of an algorithm a normalized spectrum can be generated for a specific temperature, in this case 25° C.

### EXAMPLE 3

The spectra of EXAMPLE 1 was used to determine the International Commission on Illumination (CIE) L*, a*, b* color values. The three values taken together can define a specific color; where L* is lightness, with L*=0 being an all-absorbing black and L*=100 an all-reflecting white; a* is the degree of magenta to green, with negative values being green in color and positive values being magenta; and b* is the degree of yellow to blue, with negative values being blue in color and positive values being yellow. The L*, a*, b* values indicate color as observed by the human eye and are calculated from weighted absorbance at various wavelengths.

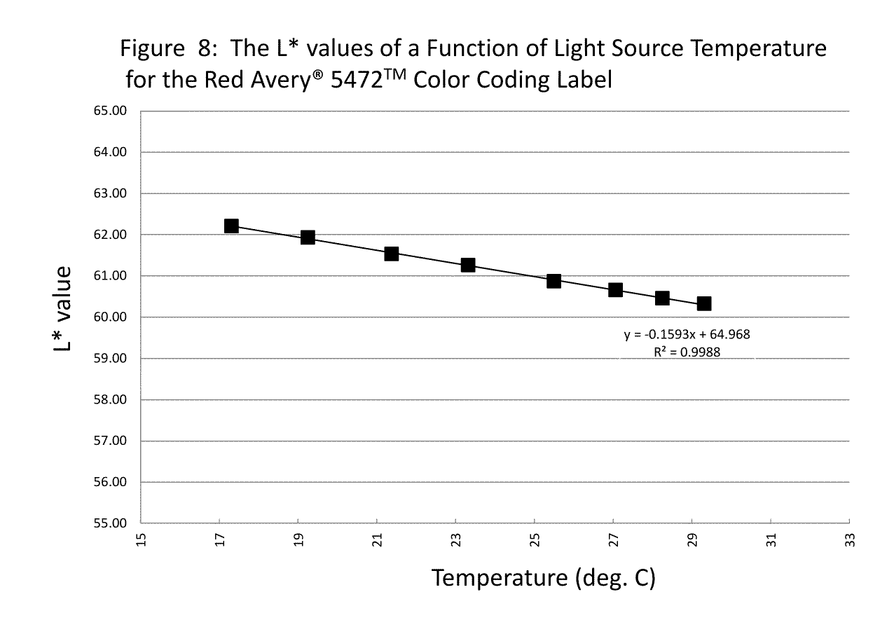

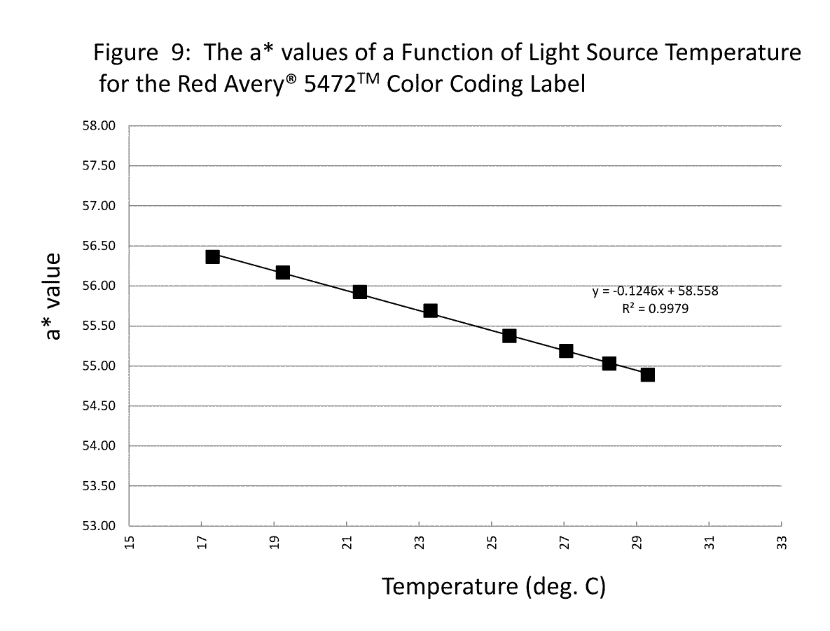

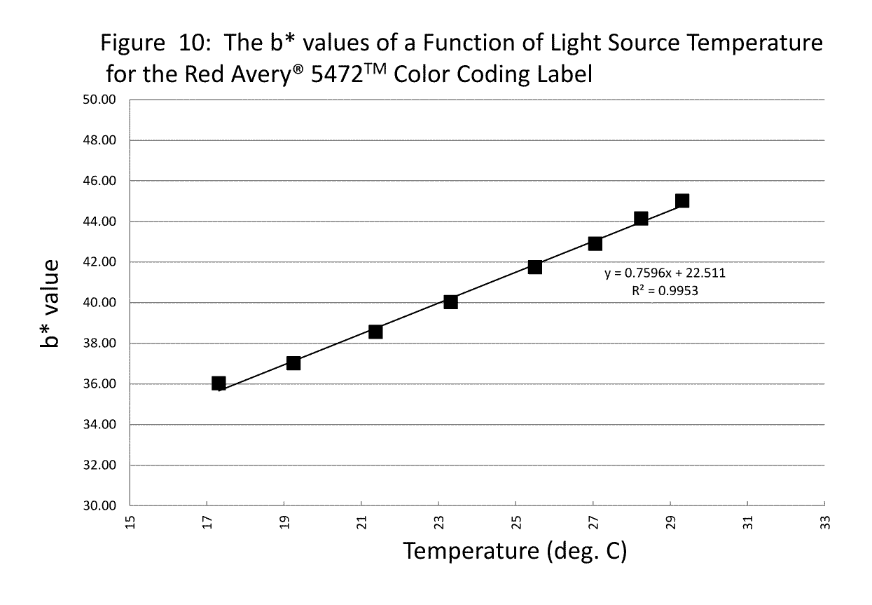

The spectral data of EXAMPLE 1 was to calculate L*, a* and b* values. FIGS. 8-10 show, respectively, the L*, a* and b* values of the red sample as a function of light source intensity. The values may be normalized with an algorithm to calculate color values for a specific temperature.

The algorithm was made by initially measuring the temperature of the light source and visible spectra and then developing a linear correlation between the temperature and the color values. Next, the color values were for a standard temperature (25° C.) was calculated and those values subtracted from the raw color values, with the resultant correlated to the light source temperature to obtain an equation. The light source temperature was put into the equation to obtain a residual for each color value. The residual, which is a function of the light source temperature, was then subtracted from the raw color value to obtain a “normalized” color value. Additionally, the algorithm may be written by measuring a minimum of two spectra and light source temperatures. The algorithm may also use non-linear equations depending on the light source temperature correlation to the spectral or color values.

Table 1 shows the measured temperature of the LEDs, along with the L*, a*, b* values before (raw) and after normalization at 25° C. In particular, these are the L*, a*, and b* Color Values (Raw and Normalized) with Temperature of Light Source for the Red Avery® 5472™ Color Coding Label.

TABLE 1

| | L* | | a* | | b* | |
|---|---|---|---|---|---|---|
| Temperature | | Normal- | | Normal- | | Normal- |
| (Deg C.) | Raw | ized | Raw | ized | Raw | ized |
| 17.31 | 62.2 | 61.0 | 56.4 | 55.4 | 36.0 | 41.9 |
| 19.25 | 61.9 | 61.0 | 56.2 | 55.4 | 37.0 | 41.4 |
| 21.38 | 61.5 | 61.0 | 55.9 | 55.4 | 38.6 | 41.3 |
| 23.32 | 61.3 | 61.0 | 55.7 | 55.4 | 40.0 | 41.3 |
| 25.50 | 60.9 | 61.0 | 55.4 | 55.4 | 41.7 | 41.4 |
| 27.06 | 60.7 | 61.0 | 55.2 | 55.4 | 42.9 | 41.3 |
| 28.25 | 60.5 | 61.0 | 55.0 | 55.4 | 44.1 | 41.7 |
| 29.31 | 60.3 | 61.0 | 54.9 | 55.4 | 45.0 | 41.7 |
| Average | 61.2 | 61.0 | 55.6 | 55.4 | 40.7 | 41.5 |
| Std Dev | 0.7 | 0.0 | 0.5 | 0.0 | 3.3 | 0.2 |

Also included are the average color values and standard deviation in measurements over the temperature range. Note the vast improvement in the uniformity of color values before and after an algorithm is applied that accounts for the temperature of the light source. The improvement is evidenced by the marked decrease in measurement standard deviations. In summary, the values show correlations between light source temperatures and color values, and that an algorithm may be further utilized to normalize calculated spectral values, such as color values for a standard temperature.

### EXAMPLE 4

The set-up and procedures of EXAMPLE 1 were followed to measure visible spectra (400 nm to 700 nm) while the temperature of the light source varied, except that the sample was now a yellow Avery® 5472™ color coding label.

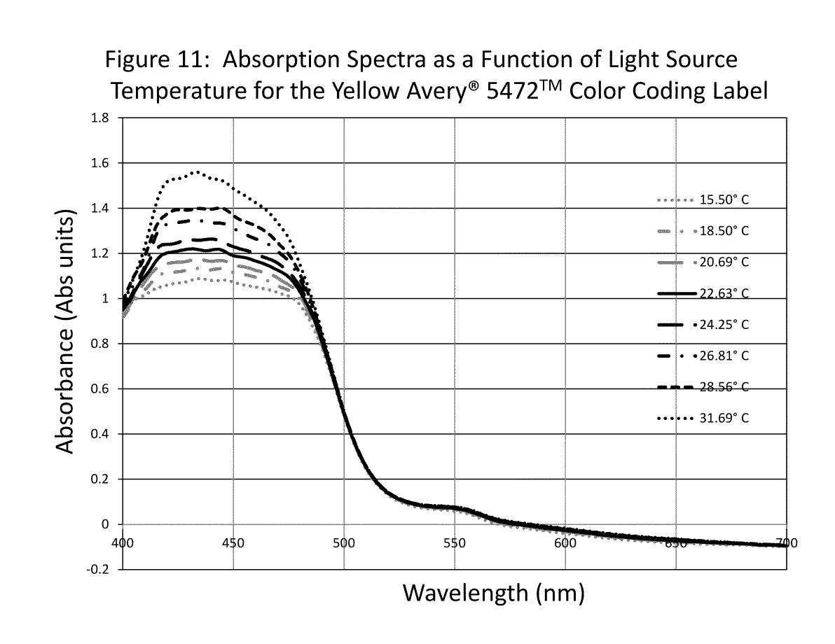

A visible spectra of the yellow label as a function of temperature is shown in FIG. 11. Note that the general effect is that as the temperature of the light source increases, the Absorbance intensity also increases. This is especially evident between the 400 nm and 480 nm region. Note also that above −550 nm the Absorbance is negative relative to the initial black standard.

### EXAMPLE 5

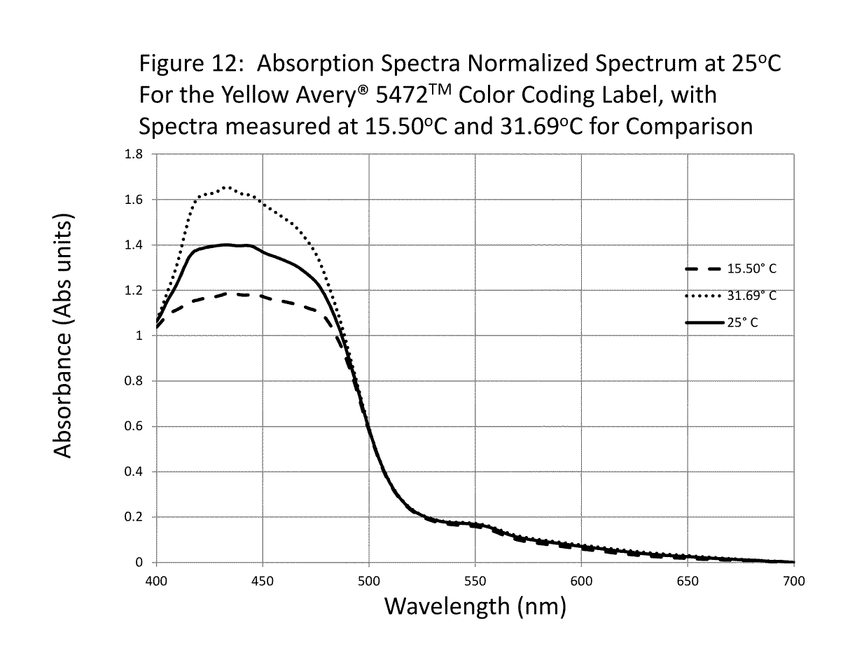

The spectra of EXAMPLE 4 were processed at each wavelength using an algorithm such that a theoretical, normalized spectrum was generated using 25° C. as the reference temperature. FIG. 12 shows the normalized spectrum from 400 nm to 700 nm using 25° C. as the calculated standard, along with two measured spectra at light source temperatures of 15.50° C. and 31.69° C., for comparative purposes. Thus, this example shows that like the red sample, there is a relationship between the temperature of a light source or sources and the resulting spectrum of a sample, in this case a yellow color coding label, and that by use of an algorithm a normalized spectrum can be generated for a specific temperature, in this case 25° C.

### EXAMPLE 6

The spectral data of EXAMPLE 4 was used to calculate L*, a* and b* values in a similar analysis manner as described in EXAMPLE 3. The raw L*, a* and b* color values were normalized with an algorithm to calculate color values for a specific temperature. Table 2 shows the measured temperature of the LEDs, along with the L*, a*, b* values before (raw) and after normalization at 25° C. In particular, The L*, a*, and b* Color Values (Raw and Normalized) with Temperature of Light Source for the Yellow Avery® 5472™ Color Coding Label. Also included are the average color values and standard deviation in measurements over the temperature range.

TABLE 2

| | L* | | a* | | b* | |
|---|---|---|---|---|---|---|
| Temperature | | Normal- | | Normal- | | Normal- |
| (Deg C.) | Raw | ized | Raw | ized | Raw | ized |
| 15.50 | 92.6 | 91.5 | 8.4 | 7.5 | 92.3 | 100.9 |
| 18.50 | 92.0 | 91.3 | 8.2 | 7.6 | 93.8 | 99.6 |
| 20.69 | 91.9 | 91.4 | 8.1 | 7.6 | 95.3 | 99.2 |
| 22.63 | 91.6 | 91.3 | 7.8 | 7.6 | 96.9 | 99.1 |
| 24.25 | 91.5 | 91.4 | 7.7 | 7.6 | 98.4 | 99.1 |
| 26.81 | 91.1 | 91.3 | 7.4 | 7.6 | 101.0 | 99.4 |
| 28.56 | 91.0 | 91.4 | 7.2 | 7.6 | 102.9 | 99.7 |
| 31.69 | 90.8 | 91.5 | 6.8 | 7.5 | 106.7 | 100.7 |
| Average | 91.6 | 91.4 | 7.7 | 7.6 | 98.4 | 99.7 |
| Std Dev | 0.6 | 0.1 | 0.5 | 0.0 | 4.9 | 0.7 |

Note from Table 2 the vast improvement in the uniformity of color values before and after an algorithm is applied that accounts for the temperature of the light source. The improvement is evidenced by the marked decrease in measurement standard deviations. In summary, the values show correlations between light source temperatures and color values for a yellow label, and that an algorithm may be further utilized to normalize calculated spectral values, such as color values for a standard temperature.

### EXAMPLE 7

The set-up and procedures of EXAMPLE 1 were followed to measure visible spectra (400 nm to 700 nm) while the temperature of the light source varied, except that the sample was now a blue Avery® 5472™ color coding label.

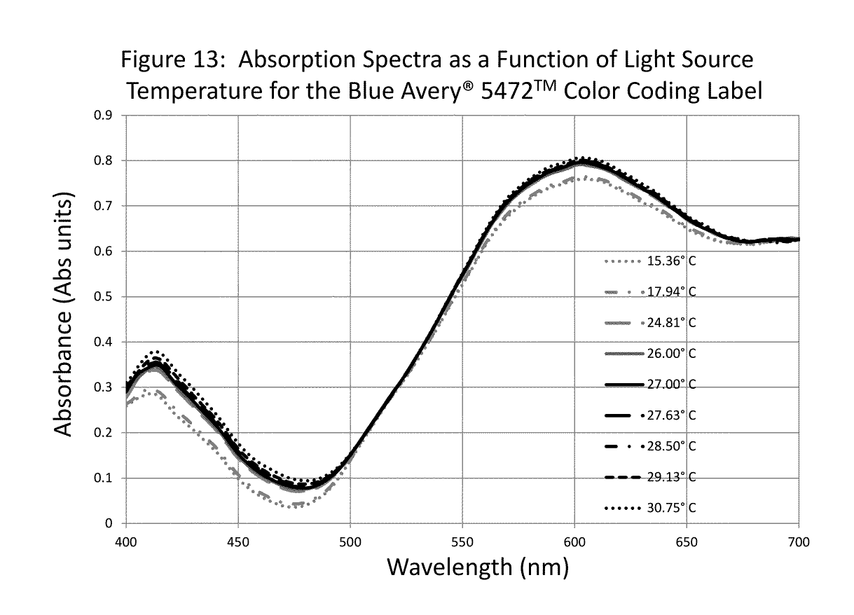

A visible spectra of the blue label as a function of temperature is shown in FIG. 13. Note that the general effect is that as the temperature of the light source increases, the Absorbance intensity also increases. This is especially evident between the 400 nm and 500 nm, and 550 nm to 675 nm regions.

### EXAMPLE 8

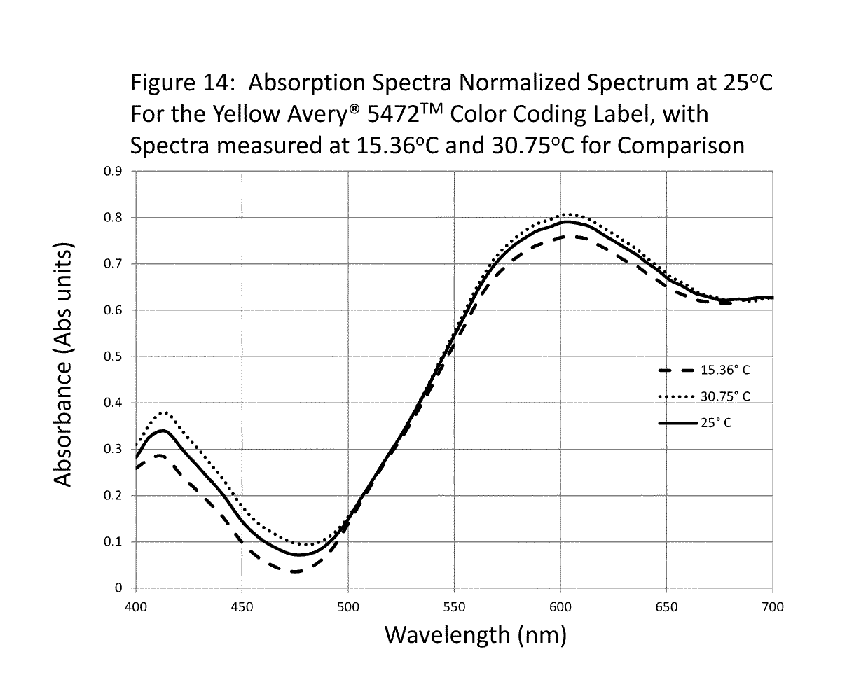

The spectra of EXAMPLE 7 were processed at each wavelength using an algorithm such that a theoretical, normalized spectrum was generated using 25° C. as the reference temperature. FIG. 14 shows the normalized spectrum from 400 nm to 700 nm using 25° C. as the calculated standard, along with two measured spectra at light source temperatures of 15.36° C. and 30.75° C., for comparative purposes. Thus, this example shows that like the red and yellow samples, there is a relationship between the temperature of a light source or sources and the resulting spectrum of a sample, in this case a blue color coding label, and that by use of an algorithm a normalized spectrum can be generated for a specific temperature, in this case 25° C.

### EXAMPLE 9

The spectral data of EXAMPLE 7 was used to calculate L*, a* and b* values in a similar analysis manner as described in EXAMPLE 3. The raw L*, a* and b* color values were normalized with an algorithm to calculate color values for a specific temperature. Table 3 shows the measured temperature of the LEDs, along with the L*, a*, b* values before (raw) and after normalization at 25° C. In particular The L*, a*, and b* Color Values (Raw and Normalized) with Temperature of Light Source for the Blue Avery® 5472™ Color Coding Label.

TABLE 3

| | L* | | a* | | b* | |
|---|---|---|---|---|---|---|
| Temperature | | Normal- | | Normal- | | Normal- |
| (Deg C.) | Raw | ized | Raw | ized | Raw | ized |
| 15.36 | 68.0 | 66.8 | −19.2 | −22.6 | −38.2 | −34.1 |
| 17.94 | 67.8 | 66.9 | −19.8 | −22.3 | −37.5 | −34.5 |
| 24.81 | 66.8 | 66.8 | −22.3 | −22.4 | −34.5 | −34.5 |
| 26.00 | 66.7 | 66.8 | −22.6 | −22.3 | −34.0 | −34.4 |
| 27.00 | 66.6 | 66.8 | −23.0 | −22.3 | −33.7 | −34.5 |
| 27.63 | 66.5 | 66.8 | −23.2 | −22.3 | −33.3 | −34.4 |
| 28.50 | 66.4 | 66.9 | −23.6 | −22.4 | −32.9 | −34.4 |
| 29.13 | 66.4 | 66.9 | −23.9 | −22.4 | −32.6 | −34.3 |
| 30.75 | 66.1 | 66.9 | −24.7 | −22.7 | −31.6 | −34.0 |
| Average | 66.8 | 66.8 | −22.5 | −22.4 | −34.3 | −34.3 |
| Std Dev | 0.7 | 0.0 | 1.8 | 0.1 | 2.2 | 0.2 |

Also included in Table 3 above are the average color values and standard deviation in measurements over the temperature range. Note the vast improvement in the uniformity of color values before and after an algorithm is applied that accounts for the temperature of the light source. The improvement is evidenced by the marked decrease in measurement standard deviations. In summary, the values show correlations between light source temperatures and color values for a blue label, and that an algorithm may be further utilized to normalize calculated spectral values, such as color values for a standard temperature.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for increasing the accuracy of spectral measurements, said method comprising:
measuring a temperature of one or more light sources that are utilized in obtaining spectral data, by use of one or more temperature sensor; and
using said light source temperatures and spectra to calculate a spectrum for a specific temperature by use of an algorithm that compensates for said light source temperatures.

2. The method of claim 1, wherein the measuring of the temperature of one or more light sources is performed by a temperature sensor in the proximity of the light source or sources.

3. The method of claim 1, wherein the spectral measurement is for one or more electromagnetic regions selected from the group consisting of: ultraviolet, visible, near infrared, mid-near-infrared, and microwave.

4. The method of claim 1, wherein the light source is formed from one or more of radiation source selected from the group consisting of: hydrogen, deuterium, tungsten, tungsten alloy, or tungsten/halogen, mercury, Nerst glower, silicon carbide or globar, incandescent wire, sodium mercury arc, helium, cadmium, argon, hollow cathode, cathode, laser, LED, klystrons, tunnel diodes and laser assisted plasma (LAMP), and flame.

5. The method of claim 3, wherein the light source is formed by LEDs that generate light in one or more of the ultraviolet, visible, or infrared regions.

6. The method of claim 3, wherein the light source generates light in the ultraviolet or visible region including a radiation source containing one or both of deuterium and hydrogen.

7. The method of claim 3, wherein the light source generates light in the visible and infrared region including a radiation source containing tungsten or tungsten-halogen.

8. The method of claim 1, wherein the temperature sensor includes a device capable of temperature measurement and selected from the group consisting of: a thermocouple, a thermistor, a resistance temperature deflector (RTD), a pyrometer, a Langmuir probe, an infrared device, and a thermometer.

9. The method of claim 1, wherein the algorithm uses a linear or non-linear correlation of spectra, wavelength intensity, or other output intensity data and relating the data to a specific light source temperature.

10. The method of claim 9, wherein the algorithm is usable to obtain absorption, transmission, and light scattering values capable of further relation to concentration and/or identification of materials.

11. The method of claim 9, wherein the algorithm is usable to obtain color values, including but not limited to, L*, a*, and b*.

12. The method of claim 1, wherein the method is utilized in an instrument comprised of one or more LEDs as said light source and a linear variable filter and sensor.

13. The method of claim 12, wherein the spectral region utilized is the ultraviolet, visible, and infrared range or combinations thereof.

14. The method of claim 12, wherein the instrument is a sensing device.

15. The method of claim 12, wherein multiple instruments may further be calibrated with each other to provide uniform results.
